(19) United States
(12) Patent Application Publication
(10) Pub. No.: US 2003/0074332 A1
(43) Pub. Date: Apr. 17, 2003

(54) Settlement procedure selection support method and settlement procedure request method

(75) Inventor: Hiroyasu Tanabe, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/112,862

(22) Filed: Apr. 2, 2002

(30) Foreign Application Priority Data
Oct. 15, 2001 (JP) 2001-316566

(51) Int. Cl. G06F 17/00

(52) U.S. Cl. 705/400; 705/26

(57) ABSTRACT

A settlement procedure selection support method according to the present invention compares a credit card handling fee imposed when a settlement procedure by credit card is selected and a remittance fee imposed when an Internet banking settlement procedure is selected. When the remittance fee is smaller than the credit card handling fee, the method according to the present invention induces a user to select the Internet banking settlement procedure having a condition that a sales agent of an Internet shopping system bears the remittance fee.

### BACKGROUND OF THE INVENTION

1. Field of the Invention

The present invention relates to a settlement procedure selection support method of relaying an online shopping system to a settlement system on the Internet, and to a settlement procedure request method.

2. Description of the Related Art

Internet shopping, in which purchasing products from a virtual store and making either an online or an offline settlement on the Internet, is becoming more popular. When considering Internet shopping as a combination of a plurality of systems, it comprises the following main systems; (1) a shopping system including the presentation of product information at virtual stores and the processing of order information, (2) a settlement system including the settlement of payment for the products ordered by users, and (3) a delivery system including the delivery of the ordered products by sales agents.

The following is a general description for the shopping system and the settlement system related to the present invention. In the shopping system, a single or a plurality of sales agents set up a virtual store or stores on the Internet and present information thereat concerning products that they sell. A user connects to the shopping system via the Internet and views the presented product information, and places an order of the preferred products, if any. Order information generated by the ordering operation includes codes and quantity of the purchased products, a total cost of the purchased products, a user identification, the user's address, and a sales agent identification, etc. Among this information, the information necessary for the settlement system or the delivering system is sent to the relevant system accordingly.

The settlement system includes an online settlement procedure and an offline settlement procedure. For the online settlement procedure, a procedure using a credit card and a procedure by remittance through Internet banking are generally used.

In case of the settlement procedure by the credit card, the sales agent (i.e. the agent of the virtual store) makes an inquiry of a credit card number of the user, etc. to a credit card company designated by the user (i.e. the purchaser) and when the user and/or the credit card number is authenticated, a settlement amount of money is paid to the sales agent from the credit company. With this method, the sales agent is to bear a credit card handling fee. The credit card handling fee is, for example, 5% of the total amount of purchase.

In case of the settlement procedure by the remittance through Internet banking, in which the total amount of the purchase is remitted to a bank account of the sales agent from a bank account of the user who has a contract with a bank for Internet banking, the user is to bear a bank remittance-handling fee (a remittance fee). The remittance fee is fixed, per bank, depending on a remittance amount and a location of a remittance designated bank account. For example, in a case of the remittance amount being less than ¥30,000 (Japanese yen), and when the bank account of the sales agent (i.e. the remittance designated bank account) is at the same bank and branch as the bank account of the user (i.e. the original bank account), the remittance fee is free. When the bank account of the sales agent is of the same bank as the user's but of a different branch, the remittance fee is ¥105, and when the bank account of the sales agent is of a different bank, the remittance is ¥210, etc.

The offline settlement procedure includes a procedure by a bank remittance, where the user goes to a bank and makes a remittance of the amount of purchase by performing the necessary procedures at a window counter of the bank or through an automated teller machine (ATM) to the bank account designated by the sales agent. In this case also, the user is to bear the remittance fee generally fixed differently, per bank, from that of Internet banking. Other than those mentioned above, there are a settlement procedure by cash in exchange for the product and a settlement procedure by invoice form, which is attached to the delivered product, where the user goes to a convenience store and pays the amount of purchase by cash thereat using the invoice form, etc.

### SUMMARY OF THE INVENTION

As mentioned above, it is a general rule that the sales agent is responsible for the credit card handling fee in the case of settlement by credit card and that the user (i.e. the purchaser) is responsible for the remittance fee in the case of settlement by bank remittance including Internet banking. Accordingly, the sales agent considers the settlement procedure by bank remittance more profitable than the settlement procedure by credit card. On the contrary, the user considers the settlement procedure by credit card advantageous.

If the sales agent is to discount as much as the remittance fee or even more, it can be considered that the user may choose the settlement procedure by bank remittance more often.

An object of the present invention is to provide a settlement procedure selection support method to induce the user to select the settlement procedure through bank remittance, which is advantageous to both the sales agent and the user, when considering the settlement of Internet shopping.

The present invention is to provide a settlement procedure advantageous to both the sales agent and the user, when considering the settlement of Internet shopping.

A description of a principle of the present invention is given with reference to FIG. 1. FIG. 1 shows, in combination, the principle of the present invention of a settlement procedure selection method carried out in a settlement procedure selection support system 1 as claimed in claim 1, claim 2, and claim 5 and a settlement procedure request method carried out in a user terminal 2 as claimed in claim 3.

First, a description is given for the settlement procedure selection support method as claimed in claim 1. The settlement procedure selection support method according to the present invention compares the credit card handling fee imposed when the settlement procedure by credit card is selected and the remittance fee imposed when the Internet banking settlement procedure is selected. When the remittance fee is smaller than the credit card handling fee, the method according to the present invention is to display a settlement procedure selection menu to the user, which induces the user to select the Internet banking settlement procedure in which the sales agent bears the remittance fee. The settlement procedure selection support method according to the present invention comprises the steps of: receiving shopping information 11, calculating the remittance fee 12, calculating the credit card handling fee 13, transmitting the settlement procedure selection menu 14, and connecting to the settlement system 15, and it also includes user bank account information 3, sales agent bank account information 4, and remittance fee information 5.

The step of receiving the shopping information 11 includes receiving information of the amount of purchase, the identification of the user purchasing the product, and the identification of the sales agent selling the purchased product, as the shopping information, from the shopping system.

The following step of calculating the remittance fee 12 includes calculating the remittance fee based on the received shopping information, the user bank account information 3, the sales agent bank account information 4, and the remittance fee information 5 previously stored. The user bank account information 3 is the information on the bank account of the user having a contract with a bank for Internet banking, which includes a bank identification code, a branch number, and a bank account number corresponding to the user identification. The sales agent bank account information 4 is the information on the sales agent, which includes a bank identification code, a branch number, and a bank account corresponding to the sales agent identification. Further, the remittance fee information 5 is the information on the remittance fee needed for Internet banking, per bank identification code, corresponding to a condition of the remittance designated bank, such as the designated bank is the same bank and the same branch as the user bank account, same bank but a different branch, or a different bank, for a predetermined remittance amount. The remittance fee can be calculated by applying a relevant condition to the remittance fee information 5.

In the following step of calculating the credit card handling fee 13, the credit card handling fee is calculated based on the amount of purchase. For example, the credit card handling fee is 5% of the amount of purchase.

In the step of transmitting the settlement procedure selection menu 14, by comparing the remittance fee and the credit card handling fee both previously calculated and determining that the remittance fee is smaller than the credit card handling fee, display information recommending the Internet banking settlement procedure having a condition that the sales agent bears the remittance fee is sent to a user terminal 2 of the user.

The step of connecting to the settlement system 15 includes receiving information on a settlement procedure selected from the settlement procedure selection menu by the user from the user terminal and connecting to a relevant settlement system corresponding to the selected settlement procedure.

In the settlement procedure selection support method claimed in claim 2, the step of transmitting the settlement procedure selection menu 14 includes making a discount in addition to the previously calculated remittance fee, and the relevant amount (i.e. the remittance fee+the discount amount) is compared to the credit card handling fee. When it is determined that the relevant amount (i.e. the remittance fee+the discount amount) is smaller than the credit card handling fee, display information recommending the Internet banking settlement procedure having a condition that the sales agent bears the remittance fee as well as provides an additional discount is sent to the user terminal 2 of the user.

Second, a description is given for the settlement procedure request method as claimed in claim 3. The settlement procedure request method according to the present invention includes transmitting, to the settlement procedure selection support system 1, of information on the settlement procedure selected by the user based on the settlement procedure selection menu in the user terminal 2 shown in FIG. 1, and comprising steps of: receiving the settlement procedure selection menu 21 and transmitting information on the selected settlement procedure 22.

The step of receiving the settlement procedure selection menu 21 includes receiving and displaying, at the user terminal 2, the display information on the settlement procedure selection menu sent from the settlement procedure selection support system 1.

The step of transmitting the information on the selected settlement procedure 22 includes transmitting, to the settlement procedure selection support system 1, the information on the settlement procedure selected by the user from the settlement procedure selection menu displayed on the user terminal 2. In other words, requesting the settlement procedure selection support system 1 to make settlement using the settlement procedure selected and designated by the user.

Last, a description is given for a settlement procedure selection support method as claimed in claim 4. The settlement procedure selection support method according to the present invention claimed in claim 1 is carried out in the settlement procedure selection support system 1 independent of the shopping system 6 and the settlement system 7. On the contrary, the settlement procedure selection support method according to the present invention claimed in claim 4 carries out the same steps in the shopping system 6 instead of in the settlement procedure selection support system 1. In this case, since the steps are carried out in the shopping system 6, it is possible to obtain the remittance fee from the amount of purchase made by the user, the bank account information of the user, and the bank account information of the sales agent as well as from the remittance fee information without receiving the shopping information. The subsequent steps of the settlement procedure selection support method according to the present invention claimed in claim 4 in relation to the settlement system are the same as the settlement procedure selection support method according to the present invention claimed in claim 1.

The settlement procedure selection support method according to the present invention as claimed in claim 5 is to induce the user to select a settlement procedure by an offline bank remittance (i.e. the user goes to the bank to make the remittance to the bank account of the sales agent by performing the necessary procedures at the window counter or through the ATM) with a condition that the sales agent is to discount the remittance fee. In this case, the remittance fee information 5 includes a remittance fee for the window-counter remittance.

According to the present invention, a settlement scheme beneficial to both the user and the sales agent, when considering the Internet shopping settlement, is provided based on the amount of purchase, and the condition of the original bank account (the user bank account) and the remittance designated bank account (the sales agent bank account).

### BRIEF DESCRIPTION OF THE DRAWINGS

Other objects, advantages, and further features of the present invention will become more apparent as the description proceeds taken in conjunction with the accompanying drawings in which:

FIG. 1 shows a principle of the present invention;

FIG. 2 shows the Internet shopping settlement procedure selection/settlement procedure request methods in one embodiment of the present invention;

FIG. 3 is a flow chart of processing in a settlement procedure selection support system according to the present invention;

FIG. 4 is a flow chart of processing in a user terminal according to the present invention;

FIG. 5 shows examples of screen images for a shopping system and the settlement procedure selection support system;

FIG. 6 is an example of a data configuration of user bank account information;

FIG. 7 is an example of a data configuration of sales agent bank account information;

FIG. 8(a) is an example of a data configuration of remittance fee information;

FIG. 8(b) is an example of a data configuration of remittance fee information

FIG. 9 is an example of a data configuration of discount information; and

FIG. 10 is the Internet shopping settlement procedure selection/settlement procedure request method in another embodiment of the present invention.

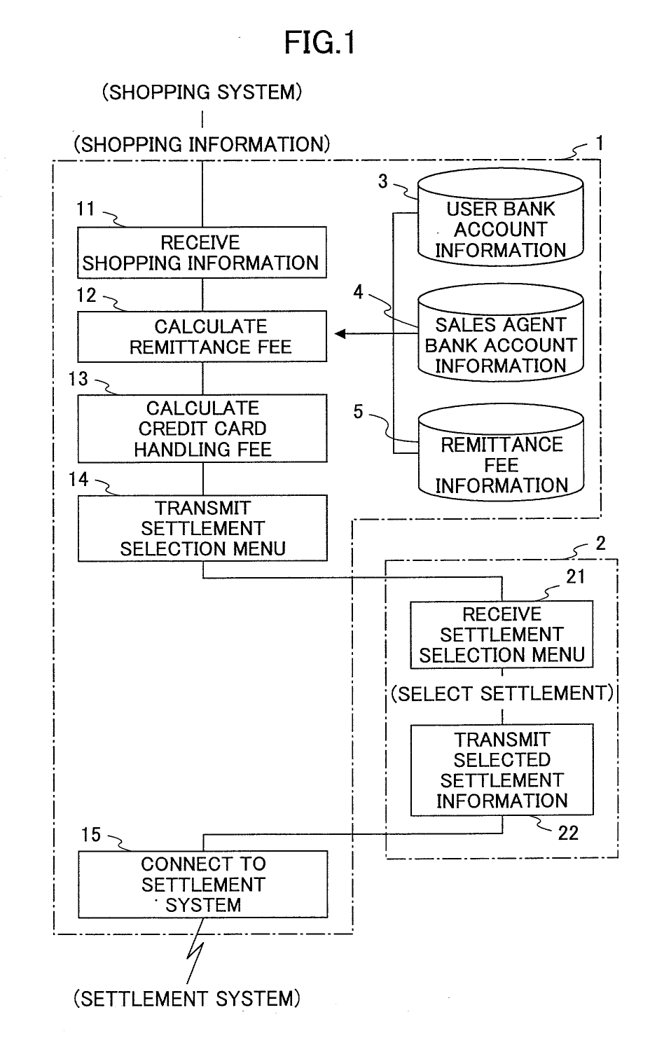

### DETAILED DESCRIPTION OF THE PREFERRED EMBODIMENT

The following is a description of embodiments of the present invention, with reference to the accompanying drawings.

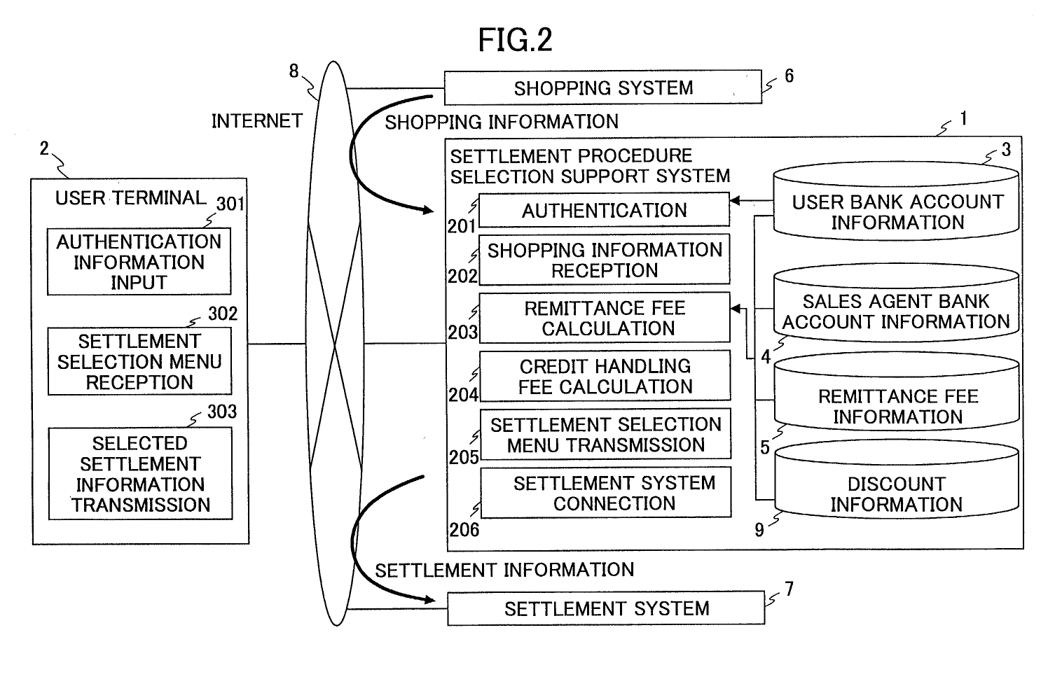

FIG. 2 shows an overall configuration of an embodiment of the present invention. According to the present invention, a shopping system 6, a settlement procedure selection support system 1, a settlement system 7, and a user terminal 2 are configured to communicate with each other through the Internet 8. A brief description on relations between these systems and the user terminal 2 is given. A user connects to the shopping system 6 using the user terminal 2 and places a purchase order of preferred products, if any, after viewing product information presented in the shopping system. The information on purchase is transferred to the settlement procedure selection support system 1 as shopping information, in which the user is requested to select a settlement procedure. The settlement procedure selection support system 1 connects to the relevant settlement system 7 of a settlement procedure designated by the user. In the settlement system 7, a settlement process is carried out accordingly depending on settlement information transferred from the settlement procedure selection support system 1. A detailed description is given on schemes of a settlement procedure selection support method carried out in the settlement procedure selection support system 1 and a settlement procedure request method carried out in the user terminal 2 in one embodiment of the present invention, with reference to FIG. 2 through FIG. 9.

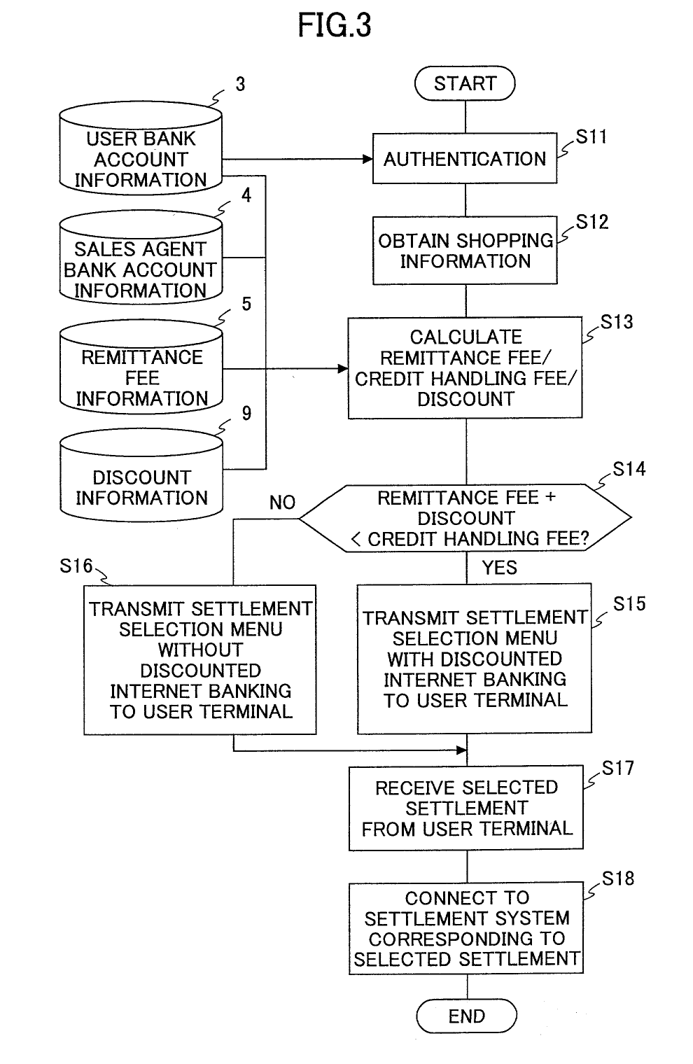

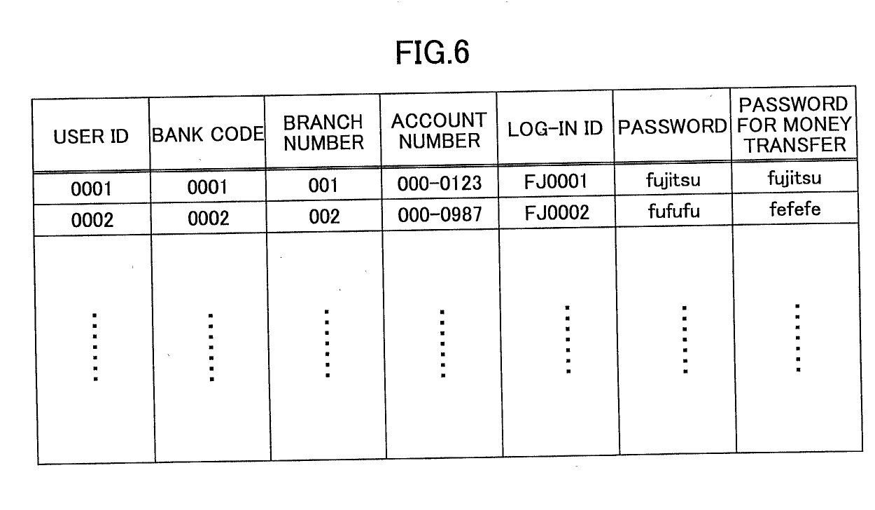

FIG. 3 is a flow chart of processing carried out in the settlement procedure selection support system 1. When the user finishes shopping in the shopping system 6, the information on the purchase is transferred to the settlement procedure selection support system 1 and the user's identification is authenticated so as to enter the settlement procedure selection support system 1. The user is requested to input a login identification and a password, and the user is authenticated as a registrant of the settlement procedure selection support system 1 by making reference to user bank account information 3 registered in advance and if the input identification matches with the user bank account information 3. An example of a data configuration of the user bank account information 3 is shown in FIG. 6. The user bank account information 3 is created in advance based on a registration of the user, and with the user identification being a key, the user bank account information 3 includes a bank code, a branch number, and an account number of a bank account of the user, as well as the log-in identification and the password to enter the settlement procedure selection support system 1, and also another password to enable money transfer from the registered bank. As can be seen, the settlement procedure selection support system 1 maintains personal information on the user, therefore, the system 1 performs an authentication process of the user identification to prevent any users other than the registrant from entering the system 1. The authentication process (S11) is carried out in an authentication function 201 shown in the settlement procedure selection support system 1 in FIG. 2. When the user is authenticated as the registrant of the settlement procedure selection support system 1, the system 1 receives the shopping information including the amount of purchase, the user identification, and the sales agent identification. The reception of the shopping information process (S12) is carried out in a shopping information reception function 202 in the settlement procedure selection support system 1 shown in FIG. 2.

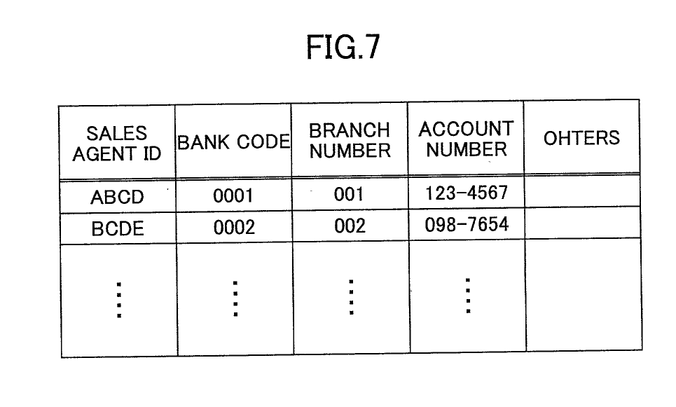

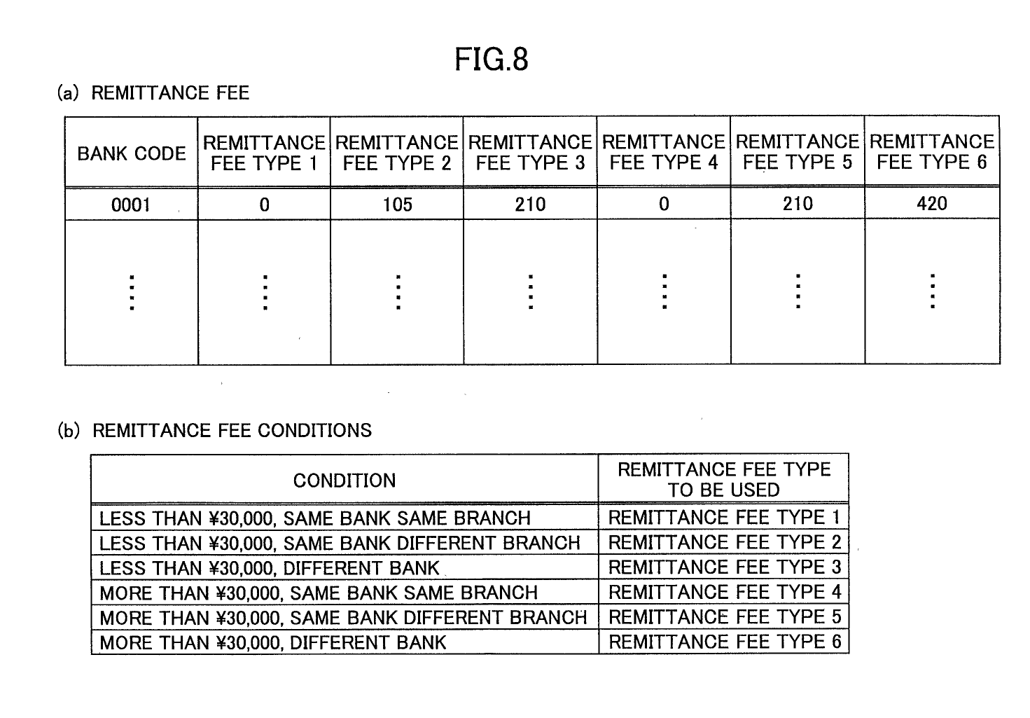

Then, the amount of purchase; the bank code and the branch number obtained by making reference to the user bank account information 3 by means of the user identification; and a bank code and a branch number obtained by making reference to sales agent bank account information 4 by means of the sales agent identification are applied to remittance fee information 5 to obtain a remittance fee. An example of a data configuration of the sales agent bank account information 4 is shown in FIG. 7. The sales agent bank account information 4 includes, with the sales agent identification being the key, the bank code, the branch number, and the bank account number. An example of a data configuration of the remittance fee information 5 is shown in FIG. 8. The remittance fee may be calculated by: first determining a remittance fee type 1 through 6 in FIG. 8(b) from a condition of the designated bank account (such as whether the sales agent bank account is at the same bank and branch as that of the user, or whether the sales agent bank account is of the same bank as the user but with a different branch, etc.) determined based on the amount of remittance (i.e. the amount of purchase), the bank code, and the branch number of the user and the sales agent respectively; and second making reference to FIG. 8(a) in which a remittance fee corresponding to the determined remittance fee type and the bank code of the user, which is the original bank, is presented. For example, in a case where the amount of purchase in the shopping system 6 is ¥50,000, the bank A being the user bank having the user bank account, and the bank B being the sales agent bank having the sales agent bank account, the remittance fee for transferring money from the bank A to the bank B matches a condition “a remittance amount more than ¥30,000 and a remittance to a different bank” and therefore, the remittance fee type is determined as “remittance fee type #6” from FIG. 8(b), and when the bank code for the bank A is “0001”, the remittance fee is determined as ¥420 from FIG. 8(a). The remittance fee information 5 has information on the remittance fee for all the bank codes registered by the users and the sales agents.

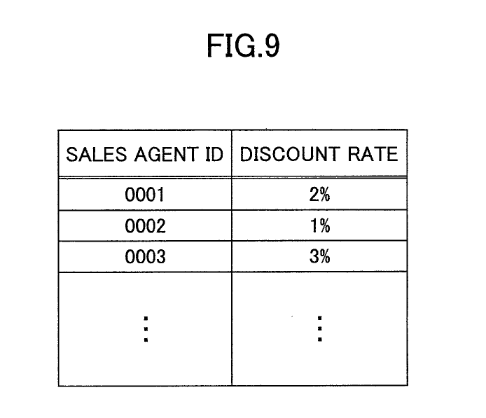

Further, the embodiment according to the present invention is assumed to be that the sales agent, who sets up virtual stores on the Internet, is to make some discount for the product they sell in addition to bearing the remittance fee. FIG. 9 shows information on a discount rate determined depending on the sales agent. A discount amount may be calculated by making reference to FIG. 9, and thus when the identification of the sales agent from whom the user has made a purchase is “0001”, then the discount rate is 2%. With the above-mentioned example where the amount of purchase is ¥50,000, the discount amount would be ¥1,000. Thus a sum of the remittance fee and the discount amount in the abovementioned example is ¥1,420 (¥1,000+¥420). This process is carried out in a remittance fee calculation function 203 in the settlement procedure selection support system 1 shown in FIG. 2.

Subsequently, the credit card handling fee is calculated using the amount of purchase obtained from the shopping information. The credit card handling fee is, for example, 5% of the amount of purchase. Therefore, for the amount of purchase of ¥50,000, the credit card handling fee would be ¥2,500. Thus, when compared to the previously calculated sum of the remittance fee and the discount amount, the calculated sum is ¥1,080 less than the credit card handling fee. This shows that if the user selects Internet banking for the settlement procedure, even when the sales agent bears the remittance fee of ¥420, the sales agent still gains a benefit of ¥1,080, and also the user gains a benefit of ¥1,000. In such a case, display information of a settlement procedure selection menu recommending the Internet banking settlement procedure with a special discount is sent to the user terminal 2. When the sum of the remittance fee and the discount amount is larger than the credit card handling fee, this would not be beneficial to the sales agent, therefore display information of a settlement procedure selection menu simply presenting regular settlement procedures is sent to the user terminal 2 of the user. A process for calculating the credit card handling fee is carried out in a credit card handling fee calculation function 204 in the settlement procedure selection support system 1 shown in FIG. 2 and a process for sending display information on the settlement procedure selection menu is carried out in a settlement procedure selection menu transmission function 205 in the settlement procedure selection support system 1 shown in FIG. 2 (S13-S15).

The settlement procedure selection support system 1 receives the settlement procedure selected by the user in response to the sent display information on the settlement procedure selection menu, and connects to a relevant settlement system of the settlement system 7 based on the selected settlement procedure. At this time, the settlement procedure selection support system 1 transfers the amount of purchase, the bank account information of the user, and the bank account information of the sales agent as settlement information to the settlement system 7 (S17-S18).

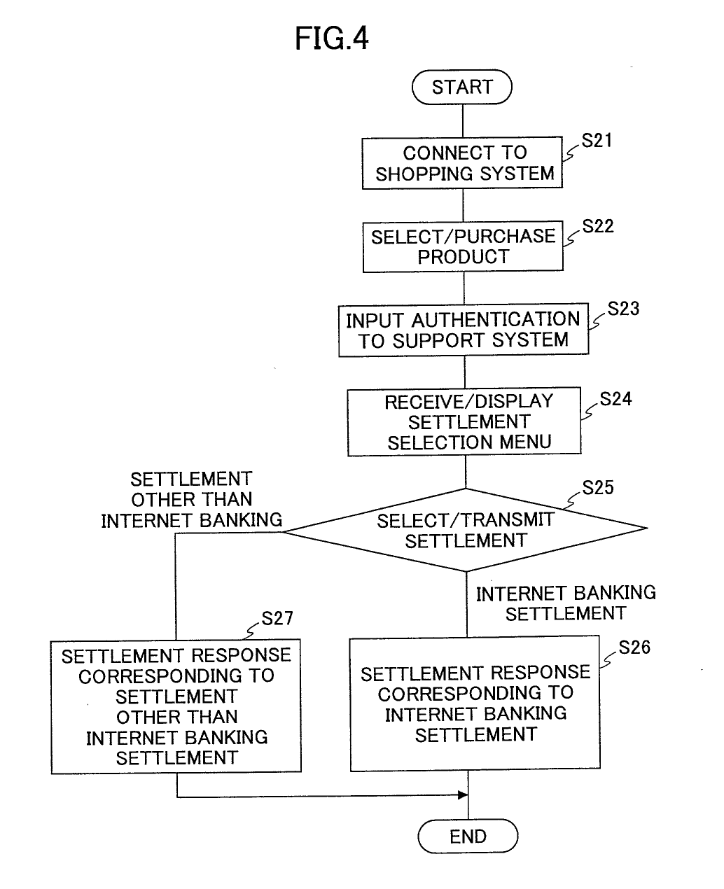

FIG. 4 is a flow chart of processing carried out in the user terminal 2 of the user. The user connects to the shopping system 6 via the Internet and places an order of a selected product (21). When the purchasing is finished, the process proceeds to the settlement procedure selection support system 1 where a settlement procedure is selected. The user is requested from the settlement procedure selection support system 1 to input authentication information comprising the user identification and the password for an authentication. The user inputs the authentication information in response to the request. A process of the authentication information is carried out in an authentication information input function 301 in the user terminal 2 shown in FIG. 2 (S23).

When the input authentication information verifies that the relevant user is a registrant of the settlement procedure selection support system 1, the user terminal 2 receives the settlement procedure selection menu sent from the settlement procedure selection support system 1 and presents it to the user. The settlement procedure selection menu may or may not include the Internet banking settlement procedure with a special discount. The user selects and designates a settlement procedure from the displayed settlement procedure selection menu, and information on the selected settlement procedure is sent to the settlement procedure selection support system 1. Subsequently, settlement process information is sent from the settlement system 7, to which the settlement procedure selection support system 1 is connected, and is displayed to the user. The user responds to the displayed information accordingly. FIG. 4 shows two cases, one case in which the Internet banking settlement procedure is selected and the other in which one of other settlement procedure including the settlement procedure by credit card is selected. In each case, settlement process information sent from the relevant settlement system 7 is displayed on a screen of the user terminal 2 and the user is to respond to the information accordingly. When the settlement procedure selection support system 1 connects to the relevant settlement system 7, and in the case of the Internet banking settlement procedure with a special discount, the amount of purchase with a discount, the bank account information from which the remittance is made (i.e. the bank account information on the user), the bank account information on the remittance designation (i.e. the bank account information on the sales agent), and the password enabling money transfer from the relevant user bank account are transferred to the settlement system 7 as the settlement information. By doing so, no additional or further information from the user is requested when connected to the settlement system 7.

A process for receiving and displaying the display information of the settlement procedure selection menu sent from the settlement procedure selection support system 1 is carried out in a settlement procedure selection menu reception function 302 in the user terminal 2 shown in FIG. 2 (S24) and a process for responding to the information on the selected settlement procedure is carried out in a settlement procedure information transmission function 303 in the user terminal 2 shown in FIG. 2 (S27).

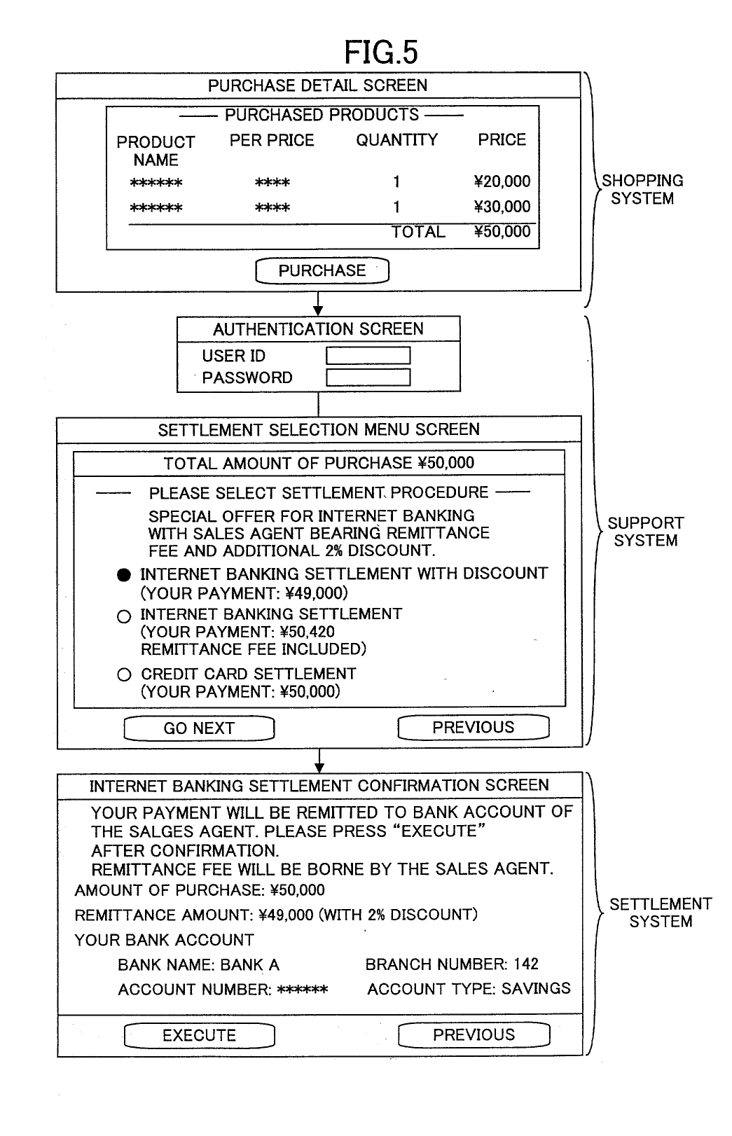

FIG. 5 shows some of the main screen images displayed on the user terminal 2 to the user during the process mentioned above. According to the screen images shown in FIG. 5, processing flows of the shopping system 6, the settlement procedure selection support system 1, and the settlement system 7 are described. At the top of FIG. 5, an example screen image displaying the purchase details from the shopping system 6 is given. When the user presses a “purchase” button after selecting a single or several products to be purchased, the total amount of the purchase is determined. When transferred to the settlement procedure selection support system 1, an authentication screen image is displayed. By inputting the user identification and the password, the user is authenticated as a registrant of the settlement procedure selection support system 1, and subsequently, a screen image of the settlement procedure selection menu is displayed to the user. The screen image of the settlement procedure selection menu shown in FIG. 5 is to include and to recommend the Internet banking settlement procedure with a special discount. If the user selects the Internet banking settlement procedure with a special discount and presses a “go next” button, a confirmation screen for a remittance through Internet banking is displayed. The user presses “execute” button after confirming the contents of the confirmation screen, then the settlement process is carried out. As shown in the confirmation screen, the user is to remit ¥49,000, which is a 2% discounted amount of the total amount of the purchase of ¥50,000. The relevant settlement system for Internet banking carries out a process of subtracting ¥420 as the remittance fee from the discounted amount of ¥49,000 and making a remittance of ¥48,580 to the bank account of the sales agent.

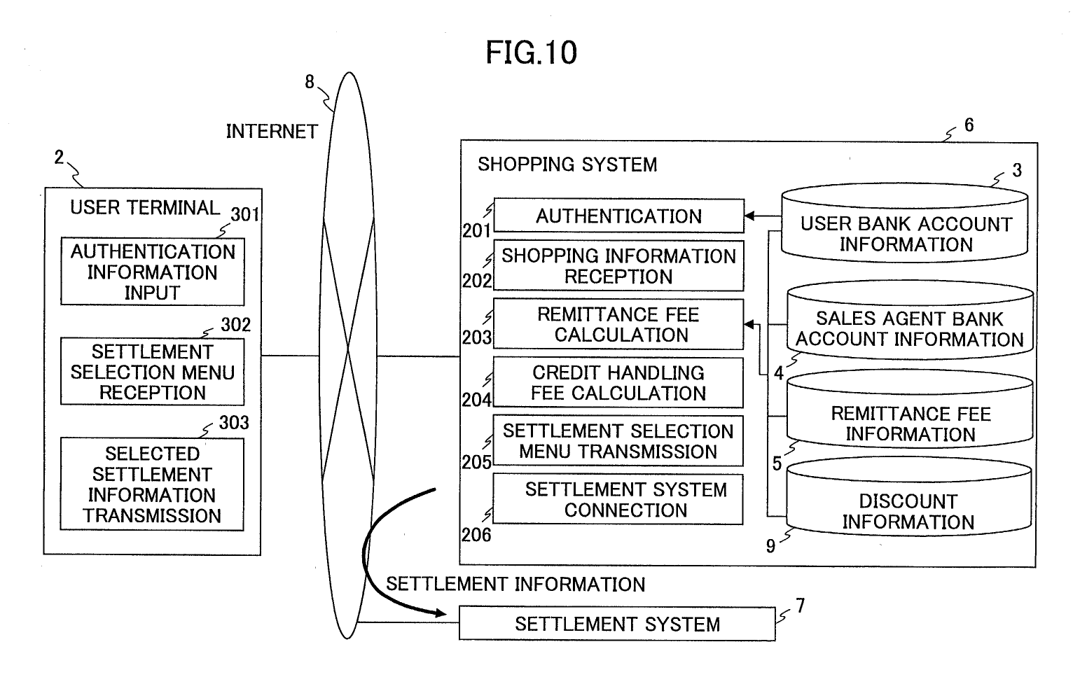

In FIG. 10, another embodiment of the present invention is shown. In the embodiment shown in FIG. 10, the shopping system 6 has the authentication function 201, the shopping information reception function 202, the remittance fee calculation function 203, the credit card handling fee calculation function 204, the settlement procedure selection menu transmission function 205, and a settlement system connection function 206, all shown in FIG. 2, and embodies one embodiment of the present invention claimed in claim 4. The process flows of the shopping system 6 and the settlement system 7, as well as of the user terminal 2 of the user is the same as mentioned above, thus will not be further described.

It is noted that in the embodiments mentioned above, the sales agent has made a discount in addition to bearing the remittance fee, however, it is also possible that the sales agent only bears the remittance fee.

In addition, the settlement procedure may be an offline bank remittance settlement procedure instead of the online Internet banking settlement procedure. In such a case, the remittance fee information 5 is to include remittance fee needed when making a remittance by performing the necessary procedures at the window counter of the bank. The reason for including the remittance fee for a window-counter-remittance is that it is not known in advance that the user will make a remittance through the bank window or an ATM, so the remittance fee for the window-counter-remittance being more expensive than the remittance fee needed for the ATM is included.

Further, the present invention is not limited to the above-described embodiments, and variations and modifications may be made without departing from the scope of the present invention.

The present application is based on Japanese priority application No. 2001-316566, filed on Oct. 15, 2001, the entire contents of which are hereby incorporated by reference.

What is claimed is:

1. A settlement procedure selection support method of relaying a shopping system to a settlement system on the Internet, characterized in that said method comprising the steps of:
a) receiving shopping information, from the shopping system, comprising an amount of purchase, a user identification of a user having a contract with a bank for Internet banking, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user settlement procedure selection menu information comprising an Internet banking settlement procedure in which the sales agent is to bear the calculated remittance fee, when the calculated remittance fee is smaller than the calculated credit card handling fee; and
e) receiving information on a settlement procedure from the terminal and connecting to a settlement system relevant to the received information.

2. A settlement procedure selection support method of relaying a shopping system to a settlement system on the Internet, characterized in that said method comprising the steps of:
a) receiving shopping information, from the shopping system, comprising an amount of purchase, a user identification of a user having a contract with a bank for Internet banking, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user, when a sum of the calculated remittance fee and a discount amount calculated from a discount rate determined for each sales agent is smaller than the calculated credit card handling fee, settlement procedure selection menu information comprising an Internet banking settlement procedure in which the sales agent is to subtract the discount amount from the amount of purchase in addition to bearing the calculated remittance fee; and
e) receiving information on a settlement procedure from the terminal and connecting to a settlement system relevant to the received information.

3. A settlement procedure request method carried out in a user terminal connected to a settlement procedure selection support system through the Internet, the settlement procedure selection support system receiving shopping information and relaying to a settlement system, characterized in that said method comprising the steps of:
a) receiving and displaying settlement procedure selection menu information requesting a selection of a settlement procedure, sent from the settlement procedure selection support system; and
b) transmitting information on a settlement procedure selected from the settlement procedure selection menu information to the settlement procedure selection support system.

4. A settlement procedure selection support method, carried out in a shopping system, connecting to a designated settlement system on the Internet, characterized in that said method comprising the steps of:
a) calculating a remittance fee from remittance fee information comprising remittance fees defined for respective banks determined from an amount of purchase, user bank account information of a user having a contract with a bank for Internet banking, and sales agent bank account information of a sales agent setting up a store in the shopping system;
b) calculating a credit card handling fee from the amount of purchase;
c) transmitting to a terminal of the user settlement procedure selection menu information comprising an Internet banking settlement procedure in which the sales agent is to bear the calculated remittance fee, when the calculated remittance fee is smaller than the calculated credit card handling fee; and
d) receiving information on a settlement procedure from the terminal and connecting to a settlement system relevant to the received information.

5. A settlement procedure selection support method of relaying a shopping system to a settlement system on the Internet, characterized in that said method comprising the steps of:
a) receiving shopping information, from the shopping system, comprising an amount of purchase, a user identification of a shopping user, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user settlement procedure selection menu information comprising a bank remittance settlement procedure in which the sales agent is to discount the calculated remittance fee from the amount of purchase, when the calculated remittance fee is smaller than the calculated credit card handling fee; and
e) receiving information on a settlement procedure from the terminal and connecting to a settlement system relevant to received information.

6. A program comprising instructions for carrying out a settlement procedure selection support method of relaying a shopping system to a settlement system on the Internet, said instructions to be carried out by a computer comprising:
a) receiving shopping information, from the shopping system, comprising an amount of purchase, a user identification of a user having a contract with a bank for Internet banking, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user settlement procedure selection menu information comprising an Internet banking settlement procedure in which the sales agent is to bear the calculated remittance fee, when the calculated remittance fee is smaller than the calculated credit card handling fee; and
e) receiving information on a settlement procedure from the terminal and connecting to a settlement system relevant to the received information.

7. A program comprising instructions for carrying out a settlement procedure selection support method of relaying a shopping system to a settlement system on the Internet, said instructions to be carried out by a computer comprising:
a) receiving shopping information, from the shopping system, comprising an amount of purchase, a user identification of a shopping user, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user settlement procedure selection menu information comprising a bank remittance settlement procedure in which the sales agent is to discount the calculated remittance fee from the amount of purchase, when the calculated remittance fee is smaller than the calculated credit card handling fee; and
e) receiving information on a settlement procedure from the terminal and connecting to a settlement system relevant to the received information.

8. An information storage medium storing a program comprising instructions for carrying out a settlement procedure selection support method of relaying a shopping system to a settlement system on the Internet, said instructions to be carried out by a computer comprising:
a) receiving shopping information, from the shopping system, comprising an amount of purchase, a user identification of a user having a contract with a bank for Internet banking, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user settlement procedure selection menu information comprising an Internet banking settlement procedure in which the sales agent is to bear the calculated remittance fee, when the calculated remittance fee is smaller than the calculated credit card handling fee; and
e) receiving information on a settlement procedure from the terminal and connecting to a settlement system relevant to the received information.

9. An information storage medium storing a program comprising instructions for carrying out a settlement procedure selection method of relaying a shopping system to a settlement system on the Internet, said instructions to be carried out by a computer comprising:
a) receiving shopping information, from the shopping system, comprising an amount of purchase, a user identification of a shopping user, and a sales agent identification of a sales agent setting up a store in the shopping system;
b) calculating a remittance fee from remittance fee information comprising remittance fees defined for respective banks determined from the shopping information, user bank account information corresponding to the user identification, and sales agent bank account information corresponding to the sales agent identification;
c) calculating a credit card handling fee from the shopping information;
d) transmitting to a terminal of the user settlement procedure selection menu information comprising a bank remittance settlement procedure in which the sales agent is to discount the calculated remittance fee from the amount of purchase, when the calculated remittance fee is smaller than the calculated credit card handling fee; and
e) receiving information on a settlement procedure from the terminal and connecting to a settlement system relevant to the received information.
